(19) United States
(12) Patent Application Publication
(10) Pub. No.: US 2020/0219265 A1
(43) Pub. Date: Jul. 9, 2020

(54) Similar Wheel Hub Model Identification System

(71) Applicant: Xiangnong Intelligent Technologies Co., Ltd., Suzhou (CN)

(72) Inventors: Xiaoming Shi, Suzhou (CN); Zhuoran Du, Suzhou (CN)

(21) Appl. No.: 16/416,262

(22) Filed: May 19, 2019

(30) Foreign Application Priority Data
Jan. 8, 2019 (CN) 201910015946.8

(51) Int. Cl. G06T 7/12; G06K 9/00; G06K 9/62; B60B 27/00

(52) U.S. Cl. CPC G06T 7/12; G06K 9/0014; G06T 2207/30108; G06K 9/6267; B60B 27/00; G06K 9/00114

(57) ABSTRACT

A similar wheel hub model identification system includes an all-in-one industrial computer, a photoelectric controller and a camera module arranged in a frame. This similar wheel hub model identification system thereby combines the machine vision technology with the image processing technology to realize the classification and identification of different models and shapes of wheel hubs. On the basis of obtaining required images by using a CCD sensor and an image processing card. Then the image is segmented to extract the features of ribs, which will be compared and classified at last to identify the similar hub. The system has the advantages of no contacting, on-line real-time identification, high accuracy, rapidity and excellent interference immunity. It can accurately classify the object in the whole manufacturing process from castings to finished products as required, which is in line with the current rapid economic development and industrial needs.

### CROSS REFERENCE TO RELATED APPLICATIONS

The present application claims the benefit of Chinese Patent Application No. 201910015946.8 filed on Jan. 8, 2019, the contents of which are incorporated herein by reference in its entirety.

### FIELD OF THE INVENTION

This invention relates to the field of automatic visual image identification, in particular to a similar wheel hub model identification system.

### BACKGROUND OF THE INVENTION

With the increasingly mature concept of automobile consumption, the automobile wheel hub industry faces new opportunities and challenges. Hub shape identification, as one of the important steps in the wheel production process, is always relying on manual identification on production line in the past, where visual fatigue easily occurs because of the high labor intensity. In addition, the rapid speed of wheel hub production line and other reasons often result in incorrect and inefficient identifications which cannot meet the needs of mass production. Particularly, with the expansion of product models, many similar hubs appear, presenting new challenges to the identification of original types on production line, as the inherent visual mode cannot fully identify those similar hubs.

During the production in smart factory, similar products such as hubs will go through several major production procedures, such as blank production (casting, riser removal, deburring, state before heat treatment, state after heat treatment, shot blasting), machining (turning and milling), cleaning, and surface painting. The workpiece shall follow different drawings in each procedure and the surfaces vary in color. Since all product models need to be first identified and then transported to the corresponding processing station, the identification of similar products has become a difficult problem.

### SUMMARY OF THE INVENTION

The main technical problem solved by this invention is to provide a similar wheel hub model identification system.

In order to solve the technical problem mentioned above, a technical solution adopted by the invention is to:

Provide a similar wheel hub model identification system, which comprises a camera module, an all-in-one industrial computer and a photoelectric controller which are arranged in a frame, wherein the camera module is used to capture wheel hub features, the industrial computer used to store wheel hub templates and features of similar wheel hubs and identify similar hubs, and the photoelectric controller used to control electric components in the identification system. The through lower part of the frame forms a transport channel where transport rails are arranged. The camera module is arranged on the top surface inside the frame, and a tetrahedron light source structure adaptive to the camera module is arranged on a side inside the frame. Hubs are conveyed into the frame through the transport rails and identified under the camera module.

In a preferred embodiment of the invention, the all-in-one industrial computer, the photoelectric controller and the camera module are arranged in an electric cabinet. A transport channel is formed under the opposite side plates of the electric cabinet, and a dark room is formed by the upper parts of the opposite side plates together with the front and rear plates of the electric cabinet.

In a preferred embodiment of the invention, a light shield is arranged on a side plate of the frame where the transport channel passes through.

In a preferred embodiment of the invention, the lower edge of the light shield contacts with the transport channel.

In a preferred embodiment of the invention, the features of similar wheel hub include the bosses on the wheel spokes or the ribs on the hub center.

In a preferred embodiment of the invention, a photoelectric sensor is arranged inside the frame to sense the hub.

In a preferred embodiment of the invention, the all-in-one industrial computer judges the similarity of hubs by comparing the image taken by the camera module with stored wheel hub templates.

In a preferred embodiment of the invention, the similar wheel hub is a wheel hub with the same hub center, spoke shape and rim.

In a preferred embodiment of the invention, the all-in-one industrial computer comprises an image preprocessing device.

In a preferred embodiment of the invention, the transport rails are arranged on a rail bracket along the transport channel.

The beneficial effects of the invention are as follows: provide a similar wheel hub model identification system, which combines the machine vision technology with the image processing technology to realize the classification and identification of different types and shapes of wheel hubs. On the basis of obtaining required images by using a CCD sensor and an image processing card, the whole image of a wheel hub is first preprocessed to determine the similarity of wheel hub model. Then the image is segmented to extract the features of ribs, which will be compared and classified at last to identify the similar hub. The system has the advantages of no contacting, on-line real-time identification, high accuracy, rapidity and excellent interference immunity. It can accurately classify the object in the whole manufacturing process from castings to finished products as required, which is in line with the current rapid economic development and industrial needs.

### BRIEF DESCRIPTION OF THE DRAWINGS

In order to more clearly illustrate the technical solutions in the embodiments of the invention, the drawings which have to be used in an embodiment will be briefly introduced hereinafter. These and other aspects of the subject invention will become readily apparent to those of ordinary skill in the art from the following detailed description together with the drawings. Other drawings can be obtained from these drawings without creative work.

FIG. 1 shows a structure diagram of the similar wheel hub model identification system.

FIG. 2 shows an overall structural drawing of the preferred embodiment 1 of the similar wheel hub model identification system;

FIG. 3 shows an overall structural drawing of the preferred embodiment 2 of the similar wheel hub model identification system;

### DETAILED DESCRIPTION

The following clearly and completely describes the technical solutions in the embodiments of the invention. Apparently, the described embodiments are only part of the embodiments of the invention and not all embodiments. Based on the embodiments illustrated by the invention, all other embodiments obtained by those of ordinary skill in the art without creative works are within the scope of protection of the invention.

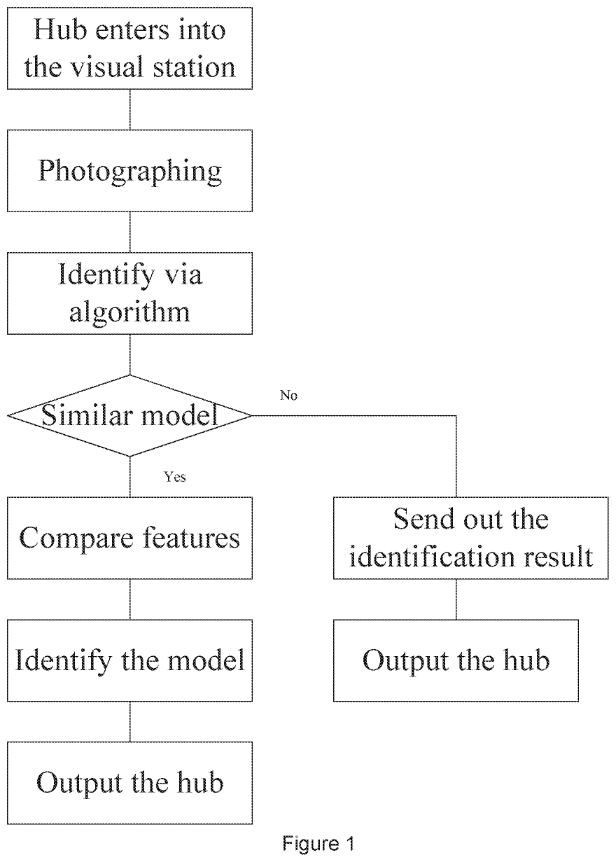

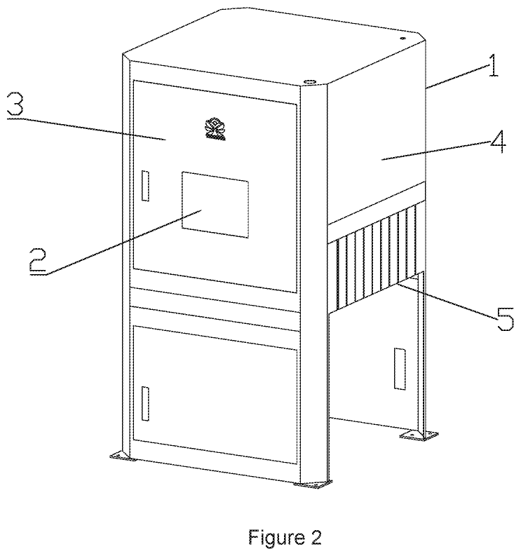

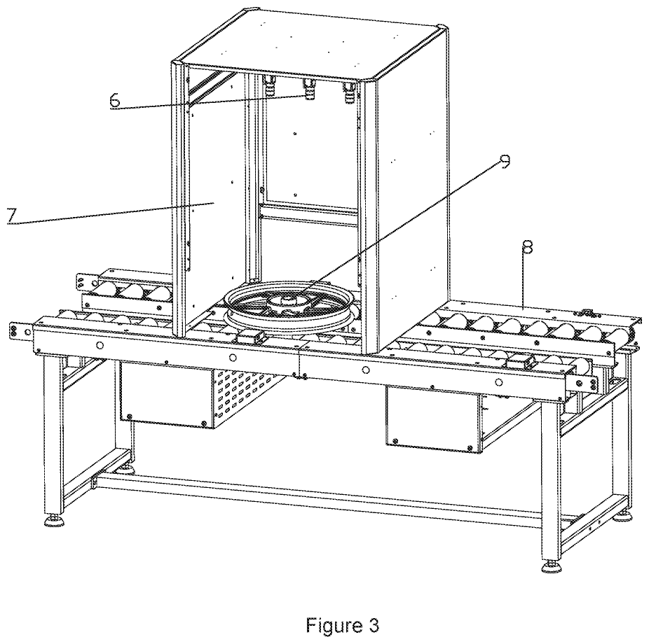

By referring to FIGS. 1-3, the embodiments of the invention include:

A similar wheel hub model identification system, comprising an all-in-one industrial computer 2 to store wheel hub templates and features of similar wheel hubs and identify similar hubs, a photoelectric controller 3 to control electric components in the identification system and a camera module 6 to capture wheel hub features.

### Embodiment 1

the through lower part of the frame 10 forms a transport channel and a rail bracket is arranged along the transport channel. Transport rails 8 are arranged on the rail bracket along the transport channel to convey the hub 9. The camera module 6 is arranged on the top plate of the frame 10, and a tetrahedron light source structure 7 adaptive to the camera module 6 is arranged on a side inside the frame 10. A photoelectric sensor is placed at the entrance where the transport rails 8 enter into the visual station. Hubs are conveyed into the frame 1 through the transport rails 8 and identified under the camera module 6.

### Embodiment 2

the all-in-one industrial computer 2, the photoelectric controller 3 and the camera module 6 are all arranged in the electric cabinet 1. A transport channel is formed under the opposite side plates of the electric cabinet 1. A rail bracket is arranged along the transport channel and transport rails 8 are arranged on the rail bracket along the transport channel to convey the hub 9. A dark room 4 is formed by the upper parts of the opposite side plates together with the front and rear plates of the electric cabinet 1 and arranged above the transport rails 8. The camera module 6 is arranged on the top plate of the dark room 4, and a tetrahedron light source structure 7 adaptive to the camera module 6 is arranged on a side of the dark room 4. Hubs are conveyed into the electric cabinet 1 through the transport rails 8 and identified under the camera module 6.

A light shield 5 is arranged at the entrance and exit of the dark room 4, and the lower edge of the light shield 5 contacts with the transport rails 8 in order to prevent the external light interference when the wheel hub is identified in the dark room 4. A photoelectric sensor is arranged at the wheel hub entrance of the electric cabinet 1.

Identification procedures of the system are:

(1) Convey hubs through the transport rails 8 into the visual station for model identification;

(2) After the photoelectric sensor detects a hub, the tetrahedron light source structure 7 opens, and the camera module 6 takes a front photograph of the hub. The all-in-one industrial computer 2 compares it with the stored wheel hub templates.

(3) If the wheel hub model is identified, convey the wheel hub out through the transport rails 8 to identify the model of next wheel hub;

(4) If the wheel hub is identified as a similar one, the all-in-one industrial computer 2 again compares the features of the hub e.g. bosses on the spokes or the ribs on the hub center, where different models can be identified by the distance between the boss and the hub center, the quantity or width of the ribs in the hub center, or the threshold set for similarity. Then output the wheel hub model.

The similar wheel hub refers to a wheel hub 9 with the same hub center, spoke shape and rim, with only individual fillets or small features that are different.

Further, the all-in-one industrial computer 2 comprises an image preprocessing device.

The beneficial effects of the similar wheel hub model identification system are as follows: the similar wheel hub model identification system disclosed in this invention can well meet the practical needs of large-scale flexible production of multiple models and fast on-line identification and classification in the period of rapid economic development. Its identification methodology realizes flexible continuous operations for hubs from casting to packaging and delivery. Various hubs which are randomly mixed together can be automatically identified and classified on the conveyor belt, which saves manpower and avoids misjudgment.

The foregoing descriptions are merely embodiments of the invention, and therefore do not mean to limit the scope of the invention. Any implementations on the content of the present specification by using an alternative structure or equivalent process transformation or direct or indirect application in the same field or in other related technical fields are in the protection scope of the invention.

What is claimed is:

1. A similar wheel hub model identification system, comprising a camera module, an all-in-one industrial computer and a photoelectric controller which are arranged in a frame, wherein the camera module is used to capture wheel hub features, the industrial computer is used to store wheel hub templates and features of similar wheel hubs and identify similar hubs, and the photoelectric controller is used to control electric components in the identification system, the through lower part of the frame forms a transport channel where transport rails are arranged, the camera module is arranged on the top surface inside the frame, and a tetrahedron light source structure adaptive to the camera module is arranged on a side inside the frame, hubs are conveyed into the frame through the transport rails and identified under the camera module.

2. The similar wheel hub model identification system as described in claim 1, wherein the all-in-one industrial computer, the photoelectric controller and the camera module are arranged in an electric cabinet, a transport channel is formed under the opposite side plates of the electric cabinet, and a dark room is formed by the upper parts of the opposite side plates together with the front and rear plates of the electric cabinet.

3. The similar wheel hub model identification system as described in claim 2, wherein a light shield is arranged on a side plate of the frame where the transport channel passes through.

4. The similar wheel hub model identification system as described in claim 3, wherein the lower edge of the light shield contacts with the transport channel.

5. The similar wheel hub model identification system as described in claim 1, wherein the features of similar wheel hub include the bosses on the wheel spokes or the ribs on the hub center.

6. The similar wheel hub model identification system as described in claim 1, wherein a photoelectric sensor is arranged inside the frame to sense the hub.

7. The similar wheel hub model identification system as described in claim 1, wherein the all-in-one industrial computer judges the similarity of hubs by comparing the image taken by the camera module with stored wheel hub templates.

8. The similar wheel hub model identification system as described in claim 1, wherein the similar wheel hub refers to a wheel hub with the same hub center, spoke shape and rim.

9. The similar wheel hub model identification system as described in claim 1, wherein the all-in-one industrial computer comprises an image preprocessing device.

10. The similar wheel hub model identification system as described in claim 1, wherein the transport rails are arranged on a rail bracket along the transport channel.
